(19) United States
(12) Patent Application Publication
(10) Pub. No.: US 2021/0130746 A1
(43) Pub. Date: May 6, 2021

(54) FABRIC CARE COMPOSITION

(71) Applicant: The Procter & Gamble Company, Cincinnati, OH (US)

(72) Inventors: Eva Maria PEREZ-PRAT VINUESA, Louveira (BR); Abigail Mary Konya, Newcstle upon Tyne (GB); Marc Johan DECLERCQ, Strombeek-Bever (BE)

(21) Appl. No.: 17/078,124

(22) Filed: Oct. 23, 2020

(30) Foreign Application Priority Data
Oct. 31, 2019 (EP) 19206618.1

(51) Int. Cl. C11D 3/48; C11D 3/34; C11D 3/28; C11D 3/30; C11D 3/50; C11D 3/37

(52) U.S. Cl. CPC C11D 3/48; C11D 3/349; C11D 3/373; C11D 3/30; C11D 3/50; C11D 3/28

(57) ABSTRACT

A fabric care composition comprising a quaternary ammonium ester compound and a bispyridinium alkane antimicrobial active.

### FIELD OF THE INVENTION

The present disclosure relates to fabric care composition that include a quaternary ammonium ester compound and an antimicrobial active. The present disclosure also relates to methods of using such compositions.

### BACKGROUND OF THE INVENTION

Fabric laundering processes provide good soil and stain removal but they do not always kill or remove the microbes present on fabrics and in the wash water. There may be a desire to provide fabric sanitization either during the laundry washing process or as an additional fabric treatment step in which the fabric is treated with a composition that may decrease the microbial load on the fabrics and/or on the treatment water, to promote further cleaning benefits. Such treatments may be particularly useful where fabrics are prone to develop malodour, for example if the fabric is not dried immediately, or where fabrics are re-wet during use and may stay damp for some time: for example if wet, laundered fabrics may remain in a washing machine for some time prior to drying, for example over 20 minutes or longer prior to drying; if laundered fabrics will be line-dried in a warm, humid environment or indoors; or if the fabrics will be damp during use, such as towels or sportswear left prior to washing. The treatment may also be particularly useful for fabrics that are not suitable to be washed at temperature above 30° C., or to be treated with bleach and harsh detergents, such as for example wool, silk, lycra, spandex and/or delicate and dark coloured garments.

As the laundry washing process becomes more energy and water efficient; wash times, wash temperatures and water volumes for rinsing are all being reduced. Also, chemical compositions for use in the process are being reformulated to reduce their environmental impact. In addition, there is an increasing number of fabrics that cannot be washed at high temperature, or with bleach-containing detergents.

Partly as a result of these changes consumers are increasingly concerned that the laundry washing process may not completely remove or kill any microbes that may be present on the fabrics or the wash water. Consumers can easily judge the performance of their detergent on cleaning stains and removing malodours but they find hard to be sure that any microbes have also been removed or killed. They want to wash at lower temperatures, and to use less harsh and fewer chemicals in the laundry washing process to be energy and water efficient and to better care for their garments, but they worry that their laundry washing process does not leave their laundry hygienically clean as microbes are known to survive these washing conditions. This leads to an unmet consumer need for sufficient fabric sanitization.

Fabric enhancer compositions continue to be popular with consumers. Such compositions can deliver softness, conditioning, and/or freshness benefits to target fabrics via a variety of benefit agents.

There is a need to provide fabric care compositions to address the unmet consumer need for sufficient fabric sanitization.

### SUMMARY OF THE INVENTION

The present disclosure relates to fabric care compositions that include a quaternized ammonium ester compound and a bispyridinium alkane. Preferably the bispyridinium alkane is octenidine dihydrochloride. The composition provides fabric care and sanitization. There is also provided a method of sanitizing a fabric using the composition of the invention.

### DETAILED DESCRIPTION OF THE INVENTION

As used herein, the articles including “the,” “a” and “an” when used in a claim or in the specification, are understood to mean one or more of what is claimed or described.

As used herein, the terms “include,” “includes” and “including” are meant to be non-limiting.

As used herein, the terms “active” and “agent” are used interchangeably.

The terms “microorganism” or “microbe” as used herein are intended to include cellular organisms, both unicellular and multicellular that are less than 5 mm in length, and include but are not limited to bacteria, fungi, prions, enveloped and non-enveloped viruses, archaea, protists, protozoa or oocysts formed by protozoa, green algae, plankton, planarian, amoebas and yeasts, or spores formed by any of these. The terms “microorganism” or “microbe” include the single or planktonic microbes that may contaminate surfaces, as well as communities of microbes that grow as biofilms on surfaces.

The term “antimicrobial” as used herein refers to a compound that exhibits microbicide or microbiostatic properties that enables the compound to kill, destroy, inactivate, or neutralize a microorganism; or to mitigate, prevent, or reduce the growth, ability to survive, or propagation of a microorganism.

As used herein, the term “alkoxy” is intended to include C1-C8 alkoxy and C1-C8 alkoxy derivatives of polyols having repeating units such as butylene oxide, glycidol oxide, ethylene oxide or propylene oxide. The terms “ethylene oxide,” “propylene oxide” and “butylene oxide” may be shown herein by their typical designation of “EO,” “PO” and “BO,” respectively.

As used herein, unless otherwise specified, the terms “alkyl” is intended to include C1-C30 alkyl groups, or even C1-C6 alkyl groups.

As used herein, unless otherwise specified, the term “aryl” is intended to include C3-12 aryl groups.

As used herein, unless otherwise specified, the term “arylalkyl” and “alkaryl” are equivalent and are each intended to include groups comprising an alkyl moiety bound to an aromatic moiety, typically having C1-C18 alkyl groups and, in one aspect, C1-C6 alkyl groups.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.001%, or less than about 0.0001%, or even 0%, by weight of the composition, of the component.

In this description, all concentrations and ratios are on a weight basis of the composition unless otherwise specified.

Unless otherwise noted, all component or composition levels are in reference to the active portion of that component or composition, and are exclusive of impurities, for example, residual solvents or by-products, which may be present in commercially available sources of such components or compositions.

All measurements are performed at 25° C. unless otherwise specified.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

### Fabric Care Composition

The present disclosure relates to fabric care compositions. The fabric care compositions of the present disclosure may contain a quaternary ammonium ester compound and a bispyridinium alkane antimicrobial active, preferably octenidine dihydrochloride. The quaternary ammonium ester compounds may act as fabric conditioning actives that may provide softness, anti-wrinkle, anti-static, conditioning, anti-stretch, color, and/or appearance benefits.

In particular, the present disclosure relates to fabric care compositions wherein: the quaternary ammonium ester compound comprises triester quaternary ammonium material (“triester quat”).

The present disclosure also relates to fabric care compositions wherein the quaternary ammonium ester compound is derived from fatty acids having an alkyl portion containing from about 13 to about 22 carbon atoms.

The present disclosure also relates to fabric care compositions wherein the quaternary ammonium ester compound comprises triester quaternary ammonium material (“triester quat”), and the quaternary ammonium ester compound is derived from fatty acids having an alkyl portion containing from about 13 to about 22 carbon atoms.

The fabric care composition may be in any suitable form. For example, the composition may be in the form of a liquid composition, a granular composition, a single-compartment pouch, a multi-compartment pouch, a dissolvable sheet, a fibrous article, a tablet, a bar, a flake, a dryer sheet, or a mixture thereof. The composition can be selected from a liquid, solid, or combination thereof. Preferably, the composition is a liquid. The liquid may be encapsulated by water-soluble film to form a unit dose article, such as a pouch.

The composition may be in the form of a liquid. The composition may include water. The composition may be aqueous. The composition, which may be a liquid composition, may comprise at least 50% by weight of water, preferably at least 90%, or even more than 95% by weight of water. The composition may comprise from about 10% to about 98%, by weight of the composition, of water, preferably from about 25% to about 96%, more preferably from about 45% to about 95%. The liquid composition may be a liquid fabric enhancer. The liquid may be packaged in a pourable bottle. The liquid may be packaged in an aerosol can or other spray bottle.

The composition may be in the form of a unitized dose article, such as a tablet, a pouch, a sheet, or a fibrous article. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof. Pouched compositions may have relatively low amounts of water, for example less than about 20%, or less than about 15%, or less than about 12%, or less than about 10%, or less than about 8%, by weight of the detergent composition, of water.

The fabric care composition may have a viscosity of from 1 to 1500 centipoises (1-1500 mPa*s), from 100 to 1000 centipoises (100-1000 mPa*s), or from 200 to 500 centipoises (200-500 mPa*s) at 20 s⁻¹ and 21° C.

The fabric care compositions of the present disclosure may be characterized by a pH of from about 2 to about 12, or from about 2 to about 8.5, or from about 2 to about 7, or from about 2 to about 5. The compositions of the present disclosure may have a pH of from about 2 to about 4, preferably a pH of from about 2 to about 3.7, more preferably a pH from about 2 to about 3.5, preferably in the form of an aqueous liquid. It is believed that such pH levels facilitate stability of the quaternary ammonium ester compound. The pH of a composition is determined by dissolving/dispersing the composition in deionized water to form a solution at 10% concentration, at about 20° C.

### Quaternary Ammonium Ester Compound

The composition may comprise a quaternary ammonium ester compound, which may act as a fabric conditioning active (“FCA”). The type and amount of quaternary ammonium ester compound may be selected for the target benefit to be delivered and/or the fabrics targeted for treatment.

The quaternary ammonium ester compound (sometimes referred to as an “ester quat”) may be present at a level of from about 0.1% to about 50%, or from about 2% to about 40%, or from about 3% to about 25%, preferably from 4% to 18%, more preferably from 5% to 15%, by weight of the composition. The quaternary ammonium ester compound may be present at a level of from greater than 0% to about 30%, or from about 1% to about 25%, or from about 3% to about 20%, or from about 4.0% to 18%, more preferably from 4.5% to 15%, even more preferably from 5.0% to 12% by weight of the composition. The quaternary ammonium ester compound may be present at a level of from about 1% to about 8%, or from about 1.5% to about 5%, by weight of the fabric care composition. The level of quaternary ammonium ester compound may depend of the desired concentration of total fabric conditioning active in the composition (diluted or concentrated composition) and of the presence (or not) of other FCAs. However, the risk on increasing viscosities over time is typically higher in fabric treatment compositions with higher FCA levels. On the other hand, at very high FCA levels, the viscosity may no longer be sufficiently controlled which renders the product unfit for use.

Quaternary ammonium ester compounds may be derived from fatty acids (sometimes called parent fatty acids). The fatty acids may include saturated fatty acids and/or unsaturated fatty acids. The fatty acids may be characterized by an iodine value (see Methods). Preferably, the iodine value of the fatty acid from which the quaternary ammonium fabric compound is formed is from 0 to 140, or from 0 to about 90, or from about 10 to about 70, or from about 15 to about 50, or from about 18 to about 30. The iodine value may be from about 25 to 50, preferably from 30 to 48, more preferably from 32 to 45. Without being bound by theory, lower melting points resulting in easier processability of the FCA are obtained when the fatty acid from which the quaternary ammonium compound is formed is at least partially unsaturated. In particular, it is believed that double unsaturated fatty acids enable easy-to-process FCAs.

The fatty acids may include an alkyl portion containing, on average by weight, from about 13 to about 22 carbon atoms, or from about 14 to about 20 carbon atoms, preferably from about 16 to about 18 carbon atoms.

Suitable fatty acids may include those derived from (1) an animal fat, and/or a partially hydrogenated animal fat, such as beef tallow, lard, etc.; (2) a vegetable oil, and/or a partially hydrogenated vegetable oil such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, etc.; (3) processed and/or bodied oils, such as linseed oil or tung oil via thermal, pressure, alkali-isomerization and catalytic treatments; (4) a mixture thereof, to yield saturated (e.g. stearic acid), unsaturated (e.g. oleic acid), polyunsaturated (linoleic acid), branched (e.g. isostearic acid) or cyclic (e.g. saturated or unsaturated α-disubstituted cyclopentyl or cyclohexyl derivatives of polyunsaturated acids) fatty acids.

The quaternary ammonium ester compound may comprise compounds formed from fatty acids that are unsaturated. The fatty acids may comprise unsaturated C18 chains, which may be include a single double bond (“C18:1”) or may be double unsaturated (“C18:2”).

The quaternary ammonium ester compound may be derived from fatty acids and optionally from triethanolamine, preferably unsaturated fatty acids that include eighteen carbons (“C18 fatty acids”), more preferably C18 fatty acids that include a single double bone (“C18:1 fatty acids”). The quaternary ammonium ester compound may comprise from about 10% to about 40%, or from about 10% to about 30%, or from about 15% to about 30%, by weight of the quaternary ammonium ester compound, of compounds derived from triethanolamine and C18:1 fatty acids. Such levels of fatty acids may facilitate handling of the resulting ester quat material.

The fatty acid from which the quaternary ammonium conditioning actives is formed may comprise from 1.0% to 20.0%, preferably from 1.5% to 18.0%, or from 3.0% to 15.0%, more preferably from 4.0% to 15.0% of double unsaturated C18 chains (“C18:2”) by weight of total fatty acid chains. From about 2% to about 10%, or from about 2% to about 8%, or from about 2% to about 6%, by weight of the total fatty acids used to form the quaternary ammonium ester compounds, may be C18:2 fatty acids.

On the other hand, very high levels of unsaturated fatty acid chains are to be avoided to minimize malodour formation as a result of oxidation of the fabric softener composition over time.

Suitable quaternary ammonium ester compounds may include materials selected from the group consisting of monoester quaternary material (“monoester quats”), diester quaternary material (“diester quats”), triester quaternary material (“trimester quats”), and mixtures thereof. The level of monoester quat may be from 2% to 40%, the level of diester quat may be from 40% to 98%, and the level of triester quat may be from 0% to 30%, by weight of total quaternary ammonium ester compound. The level of monoester quat may be from 2% to 40%, the level of diester quat may be from 40% to 98%, and the level of triester quat may be less than 5%, or less than 1%, or even 0%, by weight of total quaternary ammonium ester compound. The level of monoester quat may be from 15% to 40%, the level of diester quat may be from 40% to 60%, and the level of triester quat may be from 15% to 38%, by weight of total quaternary ammonium ester compound. The quaternary ammonium ester compound may comprise triester quaternary ammonium material (“triester quats”).

Suitable quaternary ammonium ester compounds may be derived from alkanolamines, for example, C1-C4 alkanolamines, preferably C2 alkanolamines (e.g., ethanolamines). The quaternary ammonium ester compounds may be derived from monoalkanolamines, dialkanolamines, trialkanolamines, or mixtures thereof, preferably monoethanolamines, diethanolamines, di-isopropanolamines, triethanolamines, or mixtures thereof. The quaternary ammonium ester compounds may be derived from diethanolamines. The quaternary ammonium ester compounds may be derived from di-isopropanolamines. The quaternary ammonium ester compounds may be derived from triethanolamines. The alkanolamines from which the quaternary ammonium ester compounds are derived may be alkylated mono- or dialkanolamines, for example C1-C4 alkylated alkanolamines, preferably C1 alkylated alkanolamines (e.g, N-methyldiethanolamine).

The quaternary ammonium ester compound may comprise a quaternized nitrogen atom that is substituted, at least in part. The quaternized nitrogen atom may be substituted, at least in part, with one or more C1-C3 alkyl or C1-C3 hydroxyl alkyl groups. The quaternized nitrogen atom may be substituted, at least in part, with a moiety selected from the group consisting of methyl, ethyl, propyl, hydroxyethyl, 2-hydroxypropyl, 1-methyl-2-hydroxyethyl, poly(C₂-C₃ alkoxy), polyethoxy, benzyl, more preferably methyl or hydroxyethyl.

The quaternary ammonium ester compound may comprise compounds according to Formula (I):

{R²₍₄₋ₘ₎−N+−[X−Y−R¹]ₘ}A⁻ Formula (I)

wherein:
m is 1, 2 or 3, with provisos that, in a given molecule, the value of each m is identical, and when (a) the quaternary ammonium ester compound comprises triester quaternary ammonium material (“triester quat”), for at least some of the compounds according to Formula (I), m is 3 (i.e., a triester);
each R¹, which may comprise from 13 to 22 carbon atoms, is independently a linear hydrocarbyl or branched hydrocarbyl group, preferably R¹ is linear, more preferably R¹ is partially unsaturated linear alkyl chain;
each R² is independently a C₁-C₃ alkyl or hydroxyalkyl group and/or each R² is selected from methyl, ethyl, propyl, hydroxyethyl, 2-hydroxypropyl, 1-methyl-2-hydroxyethyl, poly(C₂-C₃ alkoxy), polyethoxy, benzyl, more preferably methyl or hydroxyethyl;
each X is independently —(CH₂)n-, —CH₂—CH(CH₃)— or —CH(CH₃)—CH₂—, where each n is independently 1, 2, 3 or 4, preferably each n is 2;
each Y is independently —O—(O)C— or —C(O)—O—; and
A- is independently selected from the group consisting of chloride, bromide, methyl sulfate, ethyl sulfate, sulfate, and nitrate, preferably A- is selected from the group consisting of chloride and methyl sulfate, more preferably A- is methyl sulfate.

At least one X, preferably each X, may be independently selected from —CH₂—CH(CH₃)— or —CH(CH₃)—CH₂—. When m is 2, X may be selected from *—CH₂—CH(CH₃)—, *—CH(CH₃)—CH₂—, or a mixture thereof, where the * indicates the end nearest the nitrogen of the quaternary ammonium ester compound. When there are two or more X groups present in a single compound, at least two of the X groups may be different from each other. For example, when m is 2, one X (e.g., a first X) may be *—CH₂—CH(CH₃)—, and the other X (e.g., a second X) may be *—CH(CH₃)—CH₂—, where the * indicates the end nearest the nitrogen of the quaternary ammonium ester compound. It has been found that such selections of the m index and X groups can improve the hydrolytic stability of the quaternary ammonium ester compound, and hence further improve the stability of the composition.

For similar stability reasons, the quaternary ammonium ester compound may comprise a mixture of: bis-(2-hydroxypropyl)-dimethylammonium methylsulfate fatty acid ester; (2-hydroxypropyl)-(1-methyl-2-hydroxyethyl)-dimethylammonium methylsulfate fatty acid ester; and bis-(1-methyl-2-hydroxyethyl)-dimethylammonium methylsulfate fatty acid ester; where the fatty acid esters are produced from a C12-C18 fatty acid mixture. The quaternary ammonium ester compound may comprise any of the fatty acid esters, individually or as a mixture, listed in this paragraph.

Each X may be —(CH₂)n-, where each n is independently 1, 2, 3 or 4, preferably each n is 2.

Each R¹ group may correspond to, and/or be derived from, the alkyl portion(s) of any of the parent fatty acids provided above. The R¹ groups may comprise, by weight average, from about 13 to about 22 carbon atoms, or from about 14 to about 20 carbon atoms, preferably from about 16 to about 18 carbon atoms. It may be that when Y is *—O—(O)C— (where the * indicates the end nearest the X moiety), the sum of carbons in each R¹ is from 13 to 21, preferably from 13 to 19.

The quaternary ammonium compounds of the present disclosure may include a mixture of quaternary ammonium compounds according to Formula (I), for example, having some compounds where m=1 (e.g., monoesters) and some compounds where m=2 (e.g., diesters). Some mixtures may even contain compounds where m=3 (e.g., triesters). The quaternary ammonium compounds may include compounds according to Formula (I), where m is 1 or 2, but not 3 (e.g., is substantially free of triesters).

The quaternary ammonium compounds of the present disclosure may include compounds according to Formula (I), wherein each R² is a methyl group. The quaternary ammonium compounds of the present disclosure may include compounds according to Formula (I), wherein at least one R², preferably wherein at least one R² is a hydroxyethyl group and at least one R² is a methyl group. For compounds according to Formula (I), m may equal 1, and only one R² may be a hydroxyethyl group.

The quaternary ammonium compounds of the present disclosure may include methyl sulfate as a counterion.

The quaternary ammonium compounds of the present disclosure may comprise one or more members selected from the group consisting of:

(A) bis-(2-hydroxypropyl)-dimethylammonium methylsulfate fatty acid ester and isomers of bis-(2-hydroxypropyl)-dimethylammonium methylsulfate fatty acid ester and/or mixtures thereof; N,N-bis-(2-(acyl-oxy)-propyl)-N,N-dimethylammonium methylsulfate and/or N-(2-(acyl-oxy)-propyl)N-(2-(acyl-oxy) 1-methyl-ethyl) N,N-dimethylammonium methylsulfate and/or mixtures thereof, in which the acyl moiety is derived from c12-c22 fatty acids such as Palm, Tallow, Canola and/or other suitable fatty acids, which can be fractionated and/or hydrogenated, and/or mixtures thereof;

(B) 1,2-di(acyloxy)-3-trimethylammoniopropane chloride in which the acyl moiety is derived from c12-c22 fatty acids such as palm, tallow, canola and/or other suitable fatty acids, which can be fractionated and/or hydrogenated, and/or mixtures thereof;

(C) N,N-bis(hydroxyethyl)-N,N-dimethyl ammonium chloride fatty acid esters; N,N-bis(acyl-oxy-ethyl)-N,N-dimethyl ammonium chloride in which the acyl moiety is derived from c12-c22 fatty acids such as palm, tallow, canola and/or other suitable fatty acids, which can be fractionated and/or hydrogenated, and/or mixtures thereof, such as N,N-bis (tallowoyl-oxy-ethyl) N,N-dimethyl ammonium chloride;

(D) esterification products of Fatty Acids with Triethanolamine, quaternized with Dimethyl Sulphate; N,N-bis(acyl-oxy-ethyl)N-(2-hydroxyethyl)-N-methyl ammonium methylsulfate in which the acyl moiety is derived from c12-c22 fatty acids such as palm, tallow, canola and/or other suitable fatty acids, which can be fractionated and/or hydrogenated, and/or mixtures thereof, such as N,N-bis(tallowoyl-oxy-ethyl)N-(2-hydroxyethyl)-N-methyl ammonium methylsulfate;

(E) dicanoladimethylammonium chloride; di(hard)tallowdimethylammonium chloride; dicanoladimethylammonium methylsulfate; 1-methyl-1-stearoylamidoethyl-2-stearoylimidazolinium methylsulfate; 1-tallowylamidoethyl-2-tallowylimidazoline; dipalmylmethyl hydroxyethylammoinum methylsulfate; and/or

(F) mixtures thereof.

Examples of suitable quaternary ammonium ester compound are commercially available from Evonik under the tradename Rewoquat WE18 and/or Rewoquat WE20, and from Stepan under the tradename Stepantex GA90, Stepantex VK90, and/or Stepantex VL90A.

It is understood that compositions that comprise a quaternary ammonium ester compound as a fabric conditioning active may further comprise non-quaternized derivatives of such compounds, as well as unreacted reactants (e.g., free fatty acids).

The fabric care compositions of the present disclosure may comprise other fabric conditioning actives, for example in addition to a quaternary ammonium ester compound. Other FCAs may include silicones, non-ester quaternary ammonium compounds, amines, fatty esters, sucrose esters, silicones, dispersible polyolefins, polysaccharides, fatty acids, softening or conditioning oils, polymer latexes, or combinations thereof, preferably silicone. The combined total amount of quaternary ammonium ester compound and silicone may be from about 5% to about 70%, or from about 6% to about 50%, or from about 7% to about 40%, or from about 10% to about 30%, or from about 15% to about 25%, by weight of the composition. The composition may include a quaternary ammonium ester compound and silicone in a weight ratio of from about 1:10 to about 10:1, or from about 1:5 to about 5:1, or from about 1:3 to about 1:3, or from about 1:2 to about 2:1, or about 1:1.5 to about 1.5:1, or about 1:1.

### Antimicrobial Agent

The composition of the invention includes bispyridinium alkanes, such as the ones described in GB1533952. The term bispyridinium alkane comprises the bis[4-(substituted-amino)-1-pyridinium]alkanes of the general formulae (I) or (II)

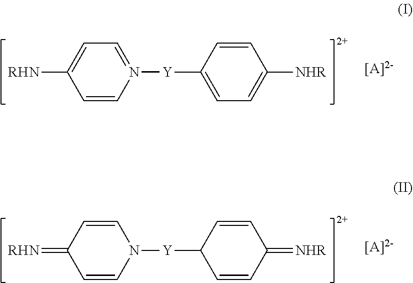

in which

Y is an alkylene or alkyl group having 4 to 18 carbon atoms,

R represents an alkyl group having 6 to 18 carbon atoms or a cycloalkyl group having 5 to 7 carbon atoms or a phenyl group with or without halogen substitution, and A is an anion or several anions.

A may be a monovalent, divalen or a polyvalent anion, for example chloride, bromide, phosphate or orthosilicate. A may also be an organic acid having the formula R4-COO˜, wherein R4 is hydrogen, hydroxyl, or C1-C40 alkyl.

Bispyridinium alkanes of the present invention comprise the various prototypes of the compounds of the formula (I) and (II) such as, for example, the ones disclosed in GB1533952 and DE19647692A1.

Other suitable bispyridinium alkanes comprise an organic acid salt of a bispyridine amine where the organic acid contains from about 4 to about 30 carbon atoms, such as, for example, the ones described in WO2014100807. Suitable organic acids include but are not limited to, carboxylic acids, such as (C1-C40) alkanecarboxylic acids which, for example, are unsubstituted or substituted by halogen, saturated or unsaturated dicarboxylic acids, such as hydroxycarboxylic acids, such as amino acids, such as (C1-C40) alkylsulfonic acids. Additional organic acids from which salts can be derived include, for example, acetic acid, propionic acid, phosphoric acid, glycolic acid, pyruvic acid, oxalic acid, maleic acid, malonic acid, succinic acid, fumaric acid, tartaric acid, citric acid, benzoic acid, cinnamic acid, mandelic acid, methanesulfonic acid, ethanesulfonic acid, p-toluenesulfonic acid, glycyrrhizinic acid, salicylic acid, stearic acid, phosphonic acid, trifluoroacetic acid, cyanoacetic acid, 4-cyanobenzoic acid, 2-chlorobenzoic acid, 2-nitrobenzoic acid, phenoxyacetic acid, benzenesulfonic acid. Preferred are salts of stearate such as bispyridinium alkane distearate.

Preferred bispyridinium alkane is octenidine dihydrochloride (R=n-octyl, Y=n-decenyl; A=2×Cl, hereinbelow “octenidine” CAS number 70775-75-6).

The fabric care composition comprises the antimicrobial agent at a level of from about 0.01 to about 10%, more preferably from 0.05% to 8%, more preferably from 0.1% to 5% by weight of the composition.

### Deposition Aid

The compositions of the present disclosure may comprise a deposition aid. Deposition aids can facilitate deposition of encapsulates, conditioning actives, perfumes, antimicrobial actives, or combinations thereof, improving the performance benefits of the compositions and/or allowing for more efficient formulation of such benefit agents. The composition may comprise, by weight of the composition, from 0.0001% to 3%, preferably from 0.0005% to 2%, more preferably from 0.001% to 1%, or from about 0.01% to about 0.5%, or from about 0.05% to about 0.3%, of a deposition aid. The deposition aid may be a cationic or amphoteric polymer, preferably a cationic polymer.

Cationic polymers in general and their methods of manufacture are known in the literature. Suitable cationic polymers may include quaternary ammonium polymers known the “Polyquaternium” polymers, as designated by the International Nomenclature for Cosmetic Ingredients, such as Polyquaternium-6 (poly(diallyldimethylammonium chloride), Polyquaternium-7 (copolymer of acrylamide and diallyldimethylammonium chloride), Polyquaternium-10 (quaternized hydroxyethyl cellulose), Polyquaternium-22 (copolymer of acrylic acid and diallyldimethylammonium chloride), and the like.

The deposition aid may be selected from the group consisting of polyvinylformamide, partially hydroxylated polyvinylformamide, polyvinylamine, polyethylene imine, ethoxylated polyethylene imine, polyvinylalcohol, polyacrylates, and combinations thereof. The cationic polymer may comprise a cationic acrylate.

Deposition aids can be added concomitantly with encapsulates (at the same time with, e.g., encapsulated benefit agents) or directly/independently in the fabric treatment composition. The weight-average molecular weight of the polymer may be from 500 to 5000000 or from 1000 to 2000000 or from 2500 to 1500000 Dalton, as determined by size exclusion chromatography relative to polyethyleneoxide standards using Refractive Index (RI) detection. The weight-average molecular weight of the cationic polymer may be from 5000 to 37500 Dalton.

### Rheology Modifier/Structurant

The compositions of the present disclosure may contain a rheology modifier and/or a structurant. Rheology modifiers may be used to “thicken” or “thin” liquid compositions to a desired viscosity. Structurants may be used to facilitate phase stability and/or to suspend or inhibit aggregation of particles in liquid composition, such as the encapsulates as described herein.

Suitable rheology modifiers and/or structurants may include non-polymeric crystalline hydroxyl functional structurants (including those based on hydrogenated castor oil), polymeric structuring agents, cellulosic fibers (for example, microfibrillated cellulose, which may be derived from a bacterial, fungal, or plant origin, including from wood), di-amido gellants, or combinations thereof.

Polymeric structuring agents may be naturally derived or synthetic in origin. Naturally derived polymeric structurants may comprise hydroxyethyl cellulose, hydrophobically modified hydroxyethyl cellulose, carboxymethyl cellulose, polysaccharide derivatives and mixtures thereof. Polysaccharide derivatives may comprise pectine, alginate, arabinogalactan (gum Arabic), carrageenan, gellan gum, xanthan gum, guar gum and mixtures thereof. Synthetic polymeric structurants may comprise polycarboxylates, polyacrylates, hydrophobically modified ethoxylated urethanes, hydrophobically modified non-ionic polyols and mixtures thereof. Polycarboxylate polymers may comprise a polyacrylate, polymethacrylate or mixtures thereof. Polyacrylates may comprise a copolymer of unsaturated mono- or di-carbonic acid and C1-C30 alkyl ester of the (meth)acrylic acid. Such copolymers are available from Noveon Inc. under the tradename Carbopol Aqua 30. Another suitable structurant is sold under the tradename Rheovis CDE, available from BASF.

### Other Adjuncts

The fabric care compositions of the present disclosure may contain other adjuncts that are suitable for inclusion in the product and/or for final usage. For example, the fabric care compositions may comprise neat perfume, perfume delivery technologies (such as pro-perfumes and/or encapsulates having non-acrylate wall materials), cationic surfactants, cationic polymers, solvents, suds supressors, or combinations thereof.

### Method of Using a Fabric Care Composition

The present disclosure further relates to methods of using a fabric care composition. For example, the present disclosure relates to methods of treating a fabric with a composition according to the present disclosure. Such methods may provide conditioning and sanitizing benefits.

The method may include a step of contacting a fabric with a fabric care composition of the present disclosure. The composition may be in neat form or diluted in a liquor, for example, a wash or rinse liquor. The composition may be diluted in water prior, during, or after contacting the surface or article. The fabric may be optionally washed and/or rinsed before and/or after the contacting step. The composition may be applied directly onto a fabric or provided to a dispensing vessel or drum of an automatic laundry machine.

The method may occur during the wash cycle or the rinse cycle, preferably the rinse cycle, of an automatic washing machine.

For purposes of the present invention, treatment may include but is not limited to, scrubbing and/or mechanical agitation. The fabric may comprise any fabric capable of being laundered or treated in normal consumer use conditions.

Liquors that comprise the disclosed compositions may have a pH of from about 3 to about 11.5. When diluted, such compositions are typically employed at concentrations of from about 500 ppm to about 15,000 ppm in solution. When the wash solvent is water, the water temperature typically ranges from about 5° C. to about 90° C. preferably from 5° C. to about 40° C., and the water to fabric ratio may be typically from about 1:1 to about 30:1.

### Combinations

Specifically contemplated combinations of the disclosure are herein described in the following lettered paragraphs. These combinations are intended to be illustrative in nature and are not intended to be limiting.

A. A fabric care composition comprising bispyridinium alkane antimicrobial active, preferably octenidine dihydrochloride and a quaternary ammonium ester compound, wherein the quaternary ammonium ester compound comprises triester quaternary ammonium material (“triester quat”) and the quaternary ammonium ester compound is derived from fatty acids having an alkyl portion containing from about 13 to about 22 carbon atoms.

B. The fabric care composition according to paragraph A, wherein the quaternary ammonium ester compound comprises compounds according to Formula (I):

{R²₍₄₋ₘ₎−N+−[X−Y−R¹]ₘ}A⁻ Formula (I)

wherein: m is 1, 2 or 3, with provisos that in a given molecule, the value of each m is identical, and when the quaternary ammonium ester compound comprises triester quaternary ammonium material (“triester quat”), for at least some of the compounds according to Formula (I), m is 3 (i.e., a triester); each R′, which optionally comprises from 13 to 22 carbon atoms, is independently a linear hydrocarbyl or branched hydrocarbyl group, preferably R¹ is linear, more preferably R¹ is partially unsaturated linear alkyl chain; each R² is independently a C1-C3 alkyl or hydroxyalkyl group and/or each R² is selected from methyl, ethyl, propyl, hydroxyethyl, 2-hydroxypropyl, 1-methyl-2-hydroxyethyl, poly(C₂-C₃ alkoxy), polyethoxy, benzyl, more preferably methyl or hydroxyethyl; each X is independently —(CH₂)n-, —CH₂—CH(CH₃)— or —CH(CH₃)—CH₂—, where each n is independently 1, 2, 3 or 4, preferably each n is 2; each Y is independently —O—(O)C— or —C(O)—O—; and A- is independently selected from the group consisting of chloride, bromide, methyl sulfate, ethyl sulfate, sulfate, and nitrate, preferably A- is selected from the group consisting of chloride and methyl sulfate, more preferably A- is methyl sulfate.

C. The fabric care composition according to paragraph B, wherein in the compound according to Formula (I), A- is methyl sulfate.

D. The fabric care composition according to any of paragraphs B-C, wherein in at least some of the compounds according to Formula (I), at least one R² is a hydroxyethyl group, preferably wherein at least one R² is a hydroxyethyl group and at least one R² is a methyl group.

E. The fabric care composition according to any of paragraphs B-D, wherein for at least some of the compounds according to Formula (I), m is 2, and each X is selected from *—CH₂—CH(CH₃)—, *—CH(CH₃)—CH₂—, or a mixture thereof, where the * indicates the end nearest the nitrogen of the quaternary ammonium ester compound, preferably wherein for at least some of the compounds according to Formula (I), the compounds comprise a first X and a second X, where the first X is *—CH₂—CH(CH₃)—, and the second X is *—CH(CH₃)—CH₂—.

F. The fabric care composition according to any of paragraphs A-E, wherein the quaternary ammonium ester compound comprises a mixture of: bis-(2-hydroxypropyl)-dimethylammonium methylsulfate fatty acid ester, (2-hydroxypropyl)-(1-methyl-2-hydroxyethyl)-dimethylammonium methylsulfate fatty acid ester, and bis-(1-methyl-2-hydroxyethyl)-dimethylammonium methylsulfate fatty acid ester, where the fatty acid esters are produced from a C12-C18 fatty acid mixture.

G. The fabric care composition according to any of paragraphs A-F, wherein the ammonium quaternary ester compound comprises material derived from unsaturated fatty acids and optionally from triethanolamine, preferably unsaturated fatty acids that include eighteen carbons (“C18”), more preferably C18 fatty acids that include a single double bond (“C18:1 fatty acids”), even more preferably wherein such material is present at a level of from about 10% to about 40%, or from about 10% to about 30%, or from about 15% to about 30%, by weight of the ammonium quaternary ester compound.

H. The fabric care composition according to any of paragraphs A-G, wherein the quaternary ammonium ester compound comprises from about 40% to about 60%, by weight of the quaternary ammonium ester compound, of a diester quaternary ammonium material (“diester quat”), and from about 15% to about 38%, by weight of the quaternary ammonium ester compound, of triester quat, preferably wherein the quaternary ammonium ester compound further comprises monoester quaternary ammonium material (“monoester quat”), preferably wherein the level of monoester quat is from 15% to 40%, by weight of the quaternary ammonium ester compound.

I. The fabric care composition according to any of paragraphs A-H, wherein the quaternary ammonium ester compound is derived from alkanolamines, preferably from monoalkanolamines, dialkanolamines, trialkanolamines, or mixtures thereof, more preferably monoethanolamines, diethanolamines, di-isopropanolamines, triethanolamines, or mixtures thereof.

J. The fabric care composition according to any of paragraphs A-I, wherein the quaternary ammonium ester compound is derived from fatty acids characterized by an iodine value of from 0 to 140, or from 0 to about 90, or from about 10 to about 70, or from about 15 to about 50, or from about 18 to about 30.

K. The fabric care composition according to any of paragraphs A-J, wherein the composition is in the form of a liquid composition, a granular composition, a single-compartment pouch, a multi-compartment pouch, a dissolvable sheet, a fibrous article, a tablet, a bar, a flake, a dryer sheet, or a mixture thereof, preferably a liquid, solid, or mixture thereof, more preferably a liquid.

L. The fabric care composition according to any of paragraphs A-K, wherein the composition is a liquid composition that comprises from about 10% to about 90%, by weight of the composition, of water, preferably from about 25% to about 80%, more preferably from about 45% to about 70%.

M. The fabric care composition according to any of paragraphs A-L, wherein the fabric care composition is characterized by a pH of from about 2 to about 12, or from about 2 to about 8.5, or from about 2 to about 7, or from about 2 to about 5, or from about 2 to about 4, from about 2 to about 3.7, more preferably from about 2 to about 3.5.

N. The fabric care composition according to any of paragraphs A-M, wherein the composition further comprises a fabric conditioning material selected from silicones, non-ester quaternary ammonium compounds, amines, fatty esters, sucrose esters, silicones, dispersible polyolefins, polysaccharides, fatty acids, softening or conditioning oils, polymer latexes, or combinations thereof, preferably silicones, more preferably where the quaternary ammonium ester compound and the silicone are present in a weight ratio of from about 1:10 to about 10:1, or from about 1:5 to about 5:1, or from about 1:3 to about 1:3, or from about 1:2 to about 2:1, or about 1:1.5 to about 1.5:1, or about 1:1.

O. The fabric care composition according to any of paragraphs A-M, wherein the composition further comprises a perfume.

P. A method of treating a fabric, the method comprising a step of contacting the fabric with a fabric care composition according to any of paragraphs A-O.

### Test Methods

### Method of Measuring Iodine Value of a Quaternary Ammonium Ester Compound

The iodine value of a quaternary ammonium ester fabric compound is the iodine value of the parent fatty acid from which the fabric conditioning active is formed, and is defined as the number of grams of iodine which react with 100 grams of parent fatty acid from which the fabric conditioning active is formed.

First, the quaternary ammonium ester compound is hydrolysed according to the following protocol: 25 g of fabric treatment composition is mixed with 50 mL of water and 0.3 mL of sodium hydroxide (50% activity). This mixture is boiled for at least an hour on a hotplate while avoiding that the mixture dries out. After an hour, the mixture is allowed to cool down and the pH is adjusted to neutral (pH between 6 and 8) with sulfuric acid 25% using pH strips or a calibrated pH electrode.

Next the fatty acid is extracted from the mixture via acidified liquid-liquid extraction with hexane or petroleum ether: the sample mixture is diluted with water/ethanol (1:1) to 160 mL in an extraction cylinder, 5 grams of sodium chloride, 0.3 mL of sulfuric acid (25% activity) and 50 mL of hexane are added. The cylinder is stoppered and shaken for at least 1 minute. Next, the cylinder is left to rest until 2 layers are formed. The top layer containing the fatty acid in hexane is transferred to another recipient. The hexane is then evaporated using a hotplate leaving behind the extracted fatty acid.

Next, the iodine value of the parent fatty acid from which the fabric conditioning active is formed is determined following ISO3961:2013. The method for calculating the iodine value of a parent fatty acid comprises dissolving a prescribed amount (from 0.1-3 g) into 15 mL of chloroform. The dissolved parent fatty acid is then reacted with 25 mL of iodine monochloride in acetic acid solution (0.1M). To this, 20 mL of 10% potassium iodide solution and 150 mL deionised water is added. After the addition of the halogen has taken place, the excess of iodine monochloride is determined by titration with sodium thiosulphate solution (0.1M) in the presence of a blue starch indicator powder. At the same time a blank is determined with the same quantity of reagents and under the same conditions. The difference between the volume of sodium thiosulphate used in the blank and that used in the reaction with the parent fatty acid enables the iodine value to be calculated.

### Method of Measuring Fatty Acid Chain Length Distribution

The fatty acid chain length distribution of the quaternary ammonium ester fabric conditioning active refers to the chain length distribution of the parent fatty acid from which the fabric conditioning active is formed. It can be measured on the quaternary ammonium ester conditioning active or on the fatty acid extracted from the fabric softener composition as described in the method to determine the iodine value of a quaternary ammonium ester fabric conditioning active. The fatty acid chain length distribution is measured by dissolving 0.2 g of the quaternary ammonium ester conditioning active or extracted fatty acid in 3 mL of 2-butanol, 3 glass beads are added and the sample is vortexed at high speed for 4 minutes. An aliquot of this extract is then transferred into a 2 mL gas chromatography vial, which is then injected into the gas chromatogram inlet (250° C.) of the gas chromatograph (Agilent GC6890N) and the resultant bi-products are separated on a DB-5 ms column (30 m×250 μm×1.0 μm, 2.0 mL/min). These bi-products are identified using a mass-spectrometer (Agilent MSD5973N, Chemstation Software version E.02.02) and the peak areas of the corresponding fatty acid chain lengths are measured. The fatty acid chain length distribution is determined by the relative ratios of the peak areas corresponding to each fatty acid chain length of interest as compared to the sum of all peaks corresponding to all fatty acid chain lengths.

### Method of Measuring Antibacterial Efficacy on Fabrics

The bactericidal efficacy on fabric surfaces of fabric enhancer compositions comprising either a bispyridinium alkane or comparative antimicrobial agents was determined against the bacterium, Staphylococcus aureus (S.aureus—ATCC #6538). The bacteria inoculum was prepared by transferring several colonies grown for 18-24h from a Tryptone Soy Agar (TSA) plate to a saline solution (0.85% NaCl), the bacteria concentration in this saline solution was determined by measuring the % Transmittance at 425 nm and adjusted by either adding more bacteria or more saline solution until the % Transmittance at 425 nm was between 23-25% which corresponds to a bacteria concentration of 108 CFU/ml.

Fabric carriers, 1 cm×1 cm disks of cotton sterilized by autoclaving, were inoculated with 30 μL of the 108 CFU/ml bacteria inoculum and incubated for 20 mins at 32° C. After this incubation period, 3 fabric carriers were placed in 30 ml of different aqueous fabric enhancer treatment liquours prepared by adding 833 mg of a fabric enhancer composition and 25 mg of either bispyridinium alkane (octenidine dihydrochloride-Tokyo Chemicals), or comparative biocides N-(3-aminopropyl)-N-dodecylpropane-1,3-diamine (Lonzabac 12.30), n-alkyl dimethyl benzyl ammonium chloride/n-alkyl dimethyl ethylbenzyl ammonium chloride (BTC2125-Stepan), or chlohexidine (Sigma-Aldrich) to water to obtain a total of 500 ml of fabric enhancer treatment solutions. A fabric enhancer treatment solution with no antimicrobial active, and a water treatment were included as reference in the test. The contact time between the bacteria in the fabric carriers and the fabric enhancer treatment solutions was 16 minutes. After this contact time each set of 3 fabric carries treated with each of the fabric enhancer treatment solutions were transferred to 9 ml of neutralizer solution (Modified Letheen Broth+1.5% Polysorbate 80, supplied by BioMérieux) to stop the antimicrobial action of the antimicrobial active present in the fabric enhancer treatment solutions. The tube containing the fabric carriers and the neutralizer solution was vortexed in a Genie 2 vortexer set at speed 7 for 30 seconds. Ten-fold serial dilutions were prepared by transferring 1 ml of the neutralizer solution containing the fabric carriers to 9 ml of a fresh neutralizer solution, this dilution step was repeated three times using as starting solution the ten-fold dilution obtained in the previous step so that serial ten-fold dilutions were obtained. 100 μL of each of the serial dilutions were plated on a TSA plate, plates were incubated at 32° C. for 18-24 hours, after this incubation time, the number of colonies in each plate was counted. The target dilution used to determine the bactericidal efficacy of the fabric enhancer compositions comprising different antimicrobial actives was the one delivering 30-300 CFU in the plate, the data reported for each antimicrobial active is the average of the bacteria number in three plates multiplied by the target dilution. The log reduction for each antibacterial treatment vs water reference is the log 10 of the number obtained by dividing the number of colonies recovered from the fabrics treated with water by the number of colonies recovered from the fabrics treated with the different fabric enhancer compositions.

### Example 1: Comparison of Antibacterial Efficacy of Bispyridinium Alkane Vs Other Antibacterial Actives in Fabric Enhancer Compositions

The antibacterial efficacy on fabrics against S.aureus of the bispyridinium alkane octenidine hydrochloride was compared to that of a quaternary ammonium, an alkylamine, and chlorhexidine antimicrobial compounds in a fabric enhancer composition (Composition 1). Composition 2 exemplifies another fabric enhancer composition suitable to comprise bispyridinium alkane octenidine hydrochloride as antimicrobial active.

| Ingredient (weight % active) | Composition 1 | Composition 2 |
|---|---|---|
| Fabric Softener Active (1) | 7.7 | — |
| Rewoquat WE18(2) | — | 8.9 |
| Refined Coconut Oil | 0.3 | — |
| Isopropanol | 0.8 | — |
| perfume | 1.0 | 1.0 |
| Formic Acid | 0.05 | — |
| Hydrochloric acid | 0.01 | 0.01 |
| Sodium salt of 1-hydroxyethane | 0.01 | — |
| 1,1-diphosphonic acid (Na HEDP) | | |
| MP10 antifoam emulsion (3) | 0.10 | — |
| Demineralised water | balance | balance |

(1) N,N-bis(hydroxyethyl)-N,N-dimethyl ammonium chloride fatty acid ester. The iodine value of the parent fatty acid of this material is between 18 and 22. The material as obtained from Evonik contains impurities in the form of free fatty acid, the monoester form of N,N-bis(hydroxyethyl)-N,N-dimethyl ammonium chloride fatty acid ester, and fatty acid esters of N,N-bis(hydroxyethyl)-N-methylamine.
(2)Di-(tallow carboxyethyl) hydroxyethyl methylammonium active methosulfate available from Evonik, 90% active
(3) MP10 ®, supplied by Dow Coming, 8% activity

Aqueous fabric enhancer treatment solutions were prepared by adding 833 mg of composition 1 and 25 mg of the different antimicrobial actives to demineralized water to obtain a total of 500 ml treatment solution of each fabric enhancer. Fabric carriers inoculated with 30 μL of a 10⁸ CFU/ml suspension of S.aureus ATCC #6538 in saline were treated with 30 ml of said aqueous fabric enhancer solutions for 16 minutes, after the treatment the fabric carriers were transferred to neutralizer solution to stop the action of the antimicrobial actives. Serial ten-fold dilutions of the neutralizer solution containing the fabric carriers were prepared and the CFU/ml in each of the serial dilution determined by plating. Table 1 shows the number of bacteria (CFU/ml) recovered from the treated fabrics, and the bacteria log reduction vs fabrics treated with water.

TABLE 1
Comparison of antibacterial efficacy of fabric enhancer compositions
comprising a bispyridine alkane vs fabric enhancer compositions
comprising other antimicrobial actives

| | Aqueous fabric enhancer solutions | | | | |
|---|---|---|---|---|---|
| | A | B | C | D | E |
| Composition 1 | 833 mg | 833 mg | 833 mg | 833 mg | 833 mg |
| Bispyridinium | — | 25 mg | — | — | |
| alkane (1) | | | | | |
| N-(3-aminopropyl)- | — | — | 25 mg | — | — |
| N-dodecylpropane- | | | | | |
| 1,3-diamine(2) | | | | | |
| n-alkyl dimethyl | — | — | — | 25 mg | — |
| benzyl ammonium | | | | | |
| chloride/n-alkyl | | | | | |
| dimethyl ethylbenzyl | | | | | |
| ammonium chloride(3) | | | | | |
| Chlorhexidine | — | — | — | — | 25 mg |
| Water | To | To | To | To | To |
| | 500 ml | 500 ml | 500 ml | 500 ml | 500 ml |
| Bacteria recovered | 5.9 × | 8.1 × | 4.6 × | 1.9 × | 4.1 × |
| (CFU/ml) | 10⁵ | 10³ | 10⁴ | 10⁴ | 10⁵ |
| Log reduction | 0.35 | 2.21 | 1.46 | 1.84 | 0.41 |
| vs water S. aureus | | | | | |

(1) Octenidine dihydrochloride (Tokyo chemicals)
(2)Lonzabac 12.30 (Lonza)
(3)BTC2125 (Stepan)

Aqueous fabric enhancer solution B comprising a bispyridinium alkane antimicrobial active is in the scope of the present invention, aqueous fabric enhancer solutions A, C, D and E are comparative examples outside of the present invention.
As can be seen in Table 1, the fabric enhancer composition of the present invention comprising octenidine hydrochloride (aqueous fabric enhancer solution B) shows higher antibacterial efficacy than any of the other fabric enhancer compositions containing comparative antimicrobial actives (comparative aqueous fabric enhancer solutions C, D and E). Very effective fabric sanitization can be provided by treating fabrics with a fabric enhancer composition comprising very low levels of a bispyridinium alkane.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric care composition comprising a quaternary ammonium ester compound and a bispyridinium alkane antimicrobial active.

2. The composition according to claim 1 wherein the bispyridinium alkane antimicrobial active is octenidine dihydrochloride.

3. The composition according to claim 1 wherein the bispyridinium alkane antimicrobial active is present at a level of from about 0.01% to about 5% by weight of the composition.

4. The composition according to claim 1 wherein the bispyridinium alkane antimicrobial active is octenidine dihydrochloride, and wherein octenidine dihydrochloride is present at a level of from about 0.01% to about 5% by weight of the composition.

5. The composition according to claim 1 wherein the quaternary ammonium ester compound comprises compounds according to Formula (I):
{R²₍₄₋ₘ₎−N+−[X−Y−R¹]ₘ}A⁻ Formula (I)
wherein:
m is 1, 2 or 3, with provisos that
in a given molecule, the value of each m is identical, and
when the quaternary ammonium ester compound comprises triester quaternary ammonium material (“triester quat”), for at least some of the compounds according to Formula (I), m is 3 (i.e., a triester);
each R¹, which comprises from 13 to 22 carbon atoms, is independently a linear hydrocarbyl or branched hydrocarbyl group;
each R² is independently a C₁-C₃ alkyl or hydroxyalkyl group and/or each R² is selected from methyl, ethyl, propyl, hydroxyethyl, 2-hydroxypropyl, 1-methyl-2-hydroxyethyl, poly(C₂-C₃ alkoxy), polyethoxy, or benzyl;
each X is independently —(CH₂)n-, —CH₂—CH(CH₃)— or —CH(CH₃)—CH₂—, where each n is independently 1, 2, 3 or 4;
each Y is independently —O—(O)C— or —C(O)—O—; and
A- is independently selected from the group consisting of chloride, bromide, methyl sulfate, ethyl sulfate, sulfate, and nitrate.

6. The composition according to claim 1 wherein the quaternary ammonium ester compound comprises compounds according to Formula (I):
{R²₍₄₋ₘ₎−N+−[X−Y−R¹]ₘ}A⁻ Formula (I)
wherein:
m is 1, 2 or 3, with provisos that
in a given molecule, the value of each m is identical, and
when the quaternary ammonium ester compound comprises triester quaternary ammonium material (“triester quat”), for at least some of the compounds according to Formula (I), m is 3 (i.e., a triester);
each R¹, which comprises from 13 to 22 carbon atoms, is independently a linear hydrocarbyl or branched hydrocarbyl group;
each R² is independently methyl or hydroxyethyl;
each X is independently —(CH₂)n-, —CH₂—CH(CH₃)— or —CH(CH₃)—CH₂—, where each n is independently 1, 2, 3 or 4;
each Y is independently —O—(O)C— or —C(O)—O—; and
A- is methyl sulfate.

7. The composition according to claim 1 wherein the quaternary ammonium ester compound comprises compounds according to Formula (I):
{R²₍₄₋ₘ₎−N+−[X−Y−R¹]ₘ}A⁻ Formula (I)
wherein:
m is 2, with proviso that in a given molecule, the value of each m is identical;
each R¹, which comprises from 13 to 22 carbon atoms, is independently a linear hydrocarbyl or branched hydrocarbyl group;
each R² is independently a C₁-C₃ alkyl or hydroxyalkyl group and/or each R² is selected from methyl, ethyl, propyl, hydroxyethyl, 2-hydroxypropyl, 1-methyl-2-hydroxyethyl, poly(C2-C3 alkoxy), polyethoxy, or benzyl;
each X is independently —(CH₂)n-, —CH₂—CH(CH₃)— or —CH(CH₃)—CH₂—, where each n is 2;
each Y is independently —O—(O)C— or —C(O)—O—; and
A- is independently selected from the group consisting of chloride, bromide, methyl sulfate, ethyl sulfate, sulfate, and nitrate.

8. The composition according to claim 1 wherein the quaternary ammonium ester compound comprises a mixture of:
bis-(2-hydroxypropyl)-dimethylammonium methylsulfate fatty acid ester,
(2-hydroxypropyl)-(1-methyl-2-hydroxyethyl)-dimethylammonium methylsulfate fatty acid ester, and
bis-(1-methyl-2-hydroxyethyl)-dimethylammonium methylsulfate fatty acid ester,
where the fatty acid esters are produced from a C12-C18 fatty acid mixture.

9. The composition according to claim 1 wherein the ammonium quaternary ester compound comprises material derived from unsaturated fatty acids and from triethanolamine.

10. The composition according to claim 1 wherein the quaternary ammonium ester compound comprises from about 40% to about 60%, by weight of the quaternary ammonium ester compound, of a diester quaternary ammonium material (“diester quat”), and from about 15% to about 38%, by weight of the quaternary ammonium ester compound, of triester quat.

11. The composition according to claim 1 wherein the quaternary ammonium ester compound comprises from about 40% to about 60%, by weight of the quaternary ammonium ester compound, of a diester quaternary ammonium material (“diester quat”), and from about 15% to about 38%, by weight of the quaternary ammonium ester compound, of triester quat, and wherein the quaternary ammonium ester compound further comprises monoester quaternary ammonium material (“monoester quat”).

12. The composition according to claim 1 wherein the quaternary ammonium ester compound comprises from about 40% to about 60%, by weight of the quaternary ammonium ester compound, of a diester quaternary ammonium material (“diester quat”), and from about 15% to about 38%, by weight of the quaternary ammonium ester compound, of triester quat, and wherein the quaternary ammonium ester compound further comprises monoester quaternary ammonium material (“monoester quat”) and wherein the level of monoester quat is from about 15.0% to about 40%, by weight of the quaternary ammonium ester compound.

13. The composition according to claim 1 wherein the quaternary ammonium ester compound is derived from monoalkanolamines, dialkanolamines, trialkanolamines, or mixtures thereof.

14. The composition according to claim 1 wherein the quaternary ammonium ester compound is derived from monoethanolamines, diethanolamines, di-isopropanolamines, triethanolamines, or mixtures thereof.

15. The composition according to claim 1 wherein the quaternary ammonium ester compound is derived from fatty acids characterized by an iodine value of from about 0 to about 140.

16. The composition according to claim 1 wherein the composition is a liquid composition that comprises from about 10% to about 98%, by weight of the composition, of water.

17. The composition according to claim 1 further comprising a perfume.

18. The composition according to claim 1 wherein the composition further comprises a fabric conditioning material selected from silicones, non-ester quaternary ammonium compounds, amines, fatty esters, sucrose esters, silicones, dispersible polyolefins, polysaccharides, fatty acids, softening or conditioning oils, polymer latexes, or combinations thereof.

19. The composition according to claim 1 wherein the composition further comprises silicone, and wherein the quaternary ammonium ester compound and the silicone are present in a weight ratio of from about 1:10 to about 10:1.

20. The composition according to claim 1 wherein the composition further comprises silicone, and wherein the quaternary ammonium ester compound and the silicone are present in a weight ratio of from about 1:2 to about 2:1.

21. A method of sanitizing a fabric, the method comprising a step of contacting the fabric with a fabric care composition according to claim 1.
